(19) United States
(12) Patent Application Publication
(10) Pub. No.: US 2015/0293903 A1
(43) Pub. Date: Oct. 15, 2015

(54) TEXT ANALYSIS

(71) Applicant: LANCASTER UNIVERSITY BUSINESS ENTERPRISES LIMITED, Lancashire (GB)

(72) Inventors: Alistair Baron, Preston (GB); Behrang Qasemizadeh, Galway (IE); Paul Edward Rayson, Lancaster (GB); James Michael Walkerdine, Lancaster (GB); Phil James Greenwood, Lancaster (GB); Muhammad Awais Rashid, Lancaster (GB)

(73) Assignee: Lancaster University Business Enterprises Limited, Lancaster (UK)

(21) Appl. No.: 14/438,709

(22) PCT Filed: Oct. 28, 2013
(86) PCT No.: PCT/GB2013/052806

§ 371 Date: Apr. 27, 2015

(30) Foreign Application Priority Data
Oct. 31, 2012 (GB) 1219594.7

(51) Int. Cl. G06F 17/27; G06F 17/21

(52) U.S. Cl. CPC G06F 17/2785; G06F 17/21

(57) ABSTRACT

A method of processing text having an associated source type to generate data indicative of a property associated with said text, said text comprising a plurality of tokens. The method comprises generating a plurality of metrics of said text based upon said plurality of tokens, the plurality of metrics comprising token count data for said plurality of tokens, part of speech data for said plurality of tokens, semantic field data for said plurality of tokens and at least one metric indicative of a property of the text; selecting reference data from a plurality of reference data based upon the source type associated with the text processing each of said plurality of metrics of said text based upon the reference data to generate data indicating a relationship between said plurality of metrics and said reference data; and combining the data indicating a relationship between the respective ones of the plurality of metrics and said reference data to generate the data indicative of a property associated with said text. The method may be applied to author profiling.

The present invention relates to methods of analysing text to generate data indicative of a property associated with the text. More particularly, but not exclusively, the present invention relates to methods of analysing text to determine a property of a persona associated with an author of the text.

The use of computers for communication is widespread. For example, the widespread use of the Internet has brought about many different communication media such as email, social networking and micro-blogging as well as text messaging from mobile phones and online gaming.

Such use of computers for communication has resulted in many different digital communities, often bringing together individuals from wide spread geographical, cultural and socio-economic backgrounds. However such digital communities provide anonymity for users such that users are able to create a persona for themselves that may not reflect reality. For example, an individual may pretend to be a different person in a digital community to in the real world, adopting various personality traits as well as assuming physical traits such as a different age or gender.

Such anonymity can be problematic and has led to various crimes that take advantage of the anonymity. For example, the Internet has provided various forums in which child sex offenders can masquerade as a young person to gain the trust of a child and also has resulted in a large number of ways in which attempts can be made to exploit an individual for financial gain such as romance scams. Accordingly it is desirable to be able to determine properties such as age and gender of an online persona based upon features other than simply what the persona purports to be.

Various text analysis methods have been developed in recent years that have been applied, for example in the analysis of authorship of text. For example, various works attributed to William Shakespeare have been analysed to determine whether authors of two different works are the same author. However analysis of text associated with online communities poses particular challenges such that application of such techniques to analysis of online communities has not to date been satisfactorily addressed and it is therefore an object of the invention to provide improvements in text analysis.

According to the invention there is provided a method of processing text having an associated source type to generate data indicative of a property associated with said text, said text comprising a plurality of tokens. The method comprises generating a plurality of metrics of said text based upon said plurality of tokens, the plurality of metrics comprising token count data for said plurality of tokens, part of speech data for said plurality of tokens, semantic field data for said plurality of tokens and at least one metric indicative of a property of the text; selecting reference data from a plurality of reference data based upon the source type associated with the text; processing each of said plurality of metrics of said text based upon the reference data to generate data indicating a relationship between respective ones of said plurality of metrics and said reference data; and combining the data indicating a relationship between the respective ones of the plurality of metrics and said reference data to generate the data indicative of a property associated with said text.

The source type may be any suitable source type and may for example indicate one of a plurality of computer mediated and online communications media including various digital communications media. The plurality of digital communications media may be selected from the group consisting of: email, social networking, micro-blogging and short message service. That is, the text that is processed may be text obtained from digital communications media that is authored by an individual or a group of individuals. Alternatively the source type may be a transcription of spoken text or any other suitable source of text.

The combining may comprise a weighted combination of the data indicating a relationship between the respective ones of the plurality of metrics and the reference data. Weights for the weighted combination may be selected based upon the associated source type. It has been found that particular metrics typically have variable significance in determining a property of text dependent upon the source of the text. As such, weighting metrics based upon the source type provides improved text analysis.

The property may be age, for example an age of an author of the text, possibly falling within a range, or a gender of an author of the text although it will be appreciated that other properties may be determined such as personality traits, influence within a group, state of happiness, social background, education, racial background, political persuasion, sexual orientation or a property relating to a language associated with the text such as whether the author is a native speaker of a language of the text.

The reference data may further be selected based upon the property associated with the text. For example, where the property is age the text may be selected such that known authors associated with the reference data have a corresponding age, for example within an age range.

The reference data may comprise corresponding word count data, part of speech data, semantic field data and at least one metric. Processing each of the plurality of metrics of said text based upon the reference data to generate data indicating a relationship between respective ones of the plurality of metrics and the reference data may comprise determining a correspondence between the reference data and the data generated from said text.

The correspondence may be based upon a count associated with at least some of the metrics. For example, the reference data may be generated from reference text by processing the reference text to determine reference metrics for comparison with the metrics generated from the text to be analysed.

Determining the correspondence may comprise determining a distance score. The distance score may be based upon a log-likelihood distance score.

The text may comprise a plurality of texts, each text having an associated source, wherein each of the plurality of texts is processed based upon respective reference data to generate respective data indicating a relationship between respective ones of said plurality of metrics and the reference data for the respective text.

Combining the data indicating a relationship between the respective ones of the plurality of metrics and the reference data to generate the data indicative of a property of the author of said text may comprise combining the respective data indicating a relationship between respective ones of said plurality of metrics and the reference data for the respective text to generate data indicative of a property of the author of each of the plurality of texts; and combining the data indicative of a property of the author of each of the plurality of texts to generate the data indicative of a property of the author of the text.

Combining the data indicative of a property of the author of each of the plurality of texts to generate the data indicative of a property of the author of the text may comprise a weighted combination. Each of the plurality of texts may be weighted based upon an amount of the respective text relative to a total amount of the plurality of texts. Alternatively the texts may be weighted based upon data indicative of the significance of a source type for a particular property, for example generated based upon regression modelling of different source types for different properties.

The author may be an individual or a persona associated with an individual or a group of individuals and/or personas.

The method may further comprise generating first data indicative of a first property of the author of said text based upon first reference data; generating second data indicative of a second property of the author of said text based upon second reference data; and selecting one of said first and second properties based upon said first and second data. Further data indicative of a further property of the author of the text may be generated based upon further reference data, the further reference data being selected based upon the selected one of the first and second properties.

The data indicating a relationship may be based upon a relative likelihood for each of the first and second properties. For example, distance scores may be generated for each of the first and second properties and the combining may take into account the relative likelihood for each of the properties based upon the distance scores for each of the properties.

The data indicative of a property associated with text may be processed to generate output data. For example, the data indicative of a property associated with text may be processed based upon a predetermined criterion and output data may be generated based upon the processing. The predetermined criterion may for example be associated with an expected property and the processing may generate an indication that the property associated with the text does not correspond to the expected property. The output data may be used to generate a warning signal to a user or may be used to transmit a signal to a further computer, for example to provide a parent or a law enforcement agency with an indication that the text is associated with suspicious activity.

Aspects of the invention can be combined and it will be readily appreciated that features described in the context of one aspect of the invention can be combined with other aspects of the invention.

It will be appreciated that aspects of the invention can be implemented in any convenient form. For example, the invention may be implemented by appropriate computer programs which may be carried on appropriate carrier media which may be tangible carrier media (e.g. disks) or intangible carrier media (e.g. communications signals). Aspects of the invention may also be implemented using suitable apparatus which may take the form of programmable computers running computer programs arranged to implement the invention.

Embodiments of the invention will now be described, by way of example, with reference to the accompanying drawings in which:

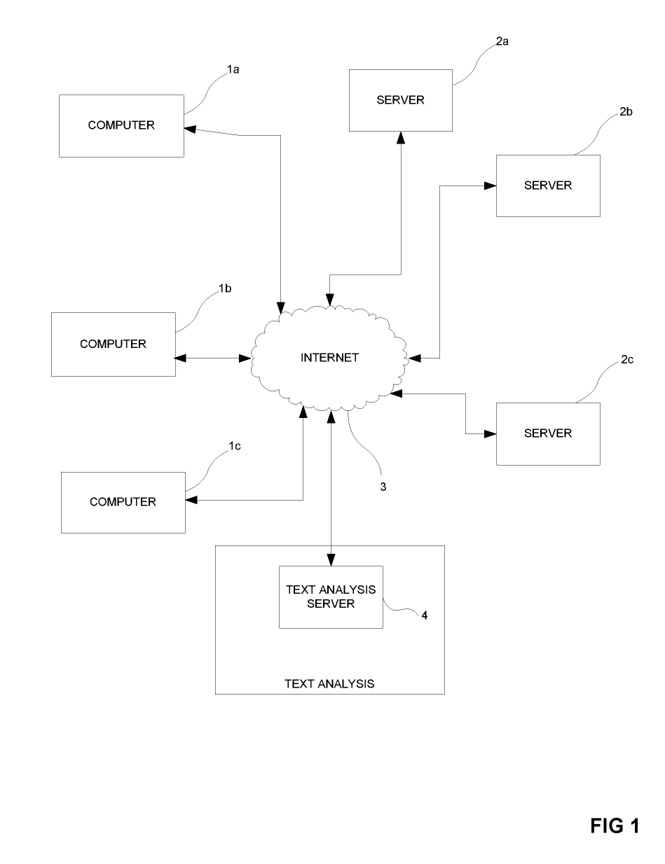

FIG. 1 is a schematic illustration of a network of computers connected together by way of the Internet in accordance with an embodiment of the invention;

FIG. 1A is a schematic illustration of a computer suitable for carrying out the invention;

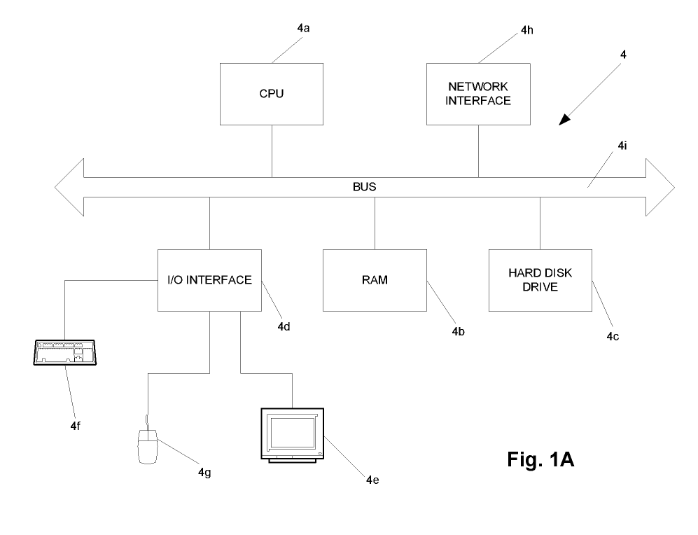

FIG. 2 is a flow chart schematically showing processing of text data to generate data indicative of a property associated with the text;

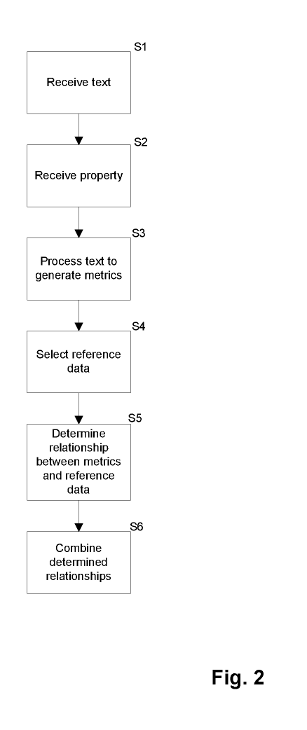

FIG. 3 is a flow chart showing processing carried out to generate metrics from text;

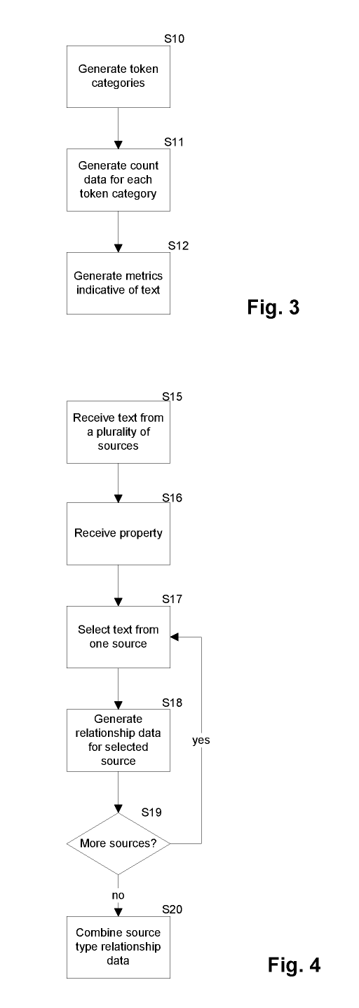

FIG. 4 is a flowchart showing processing of text data from a plurality of source types;

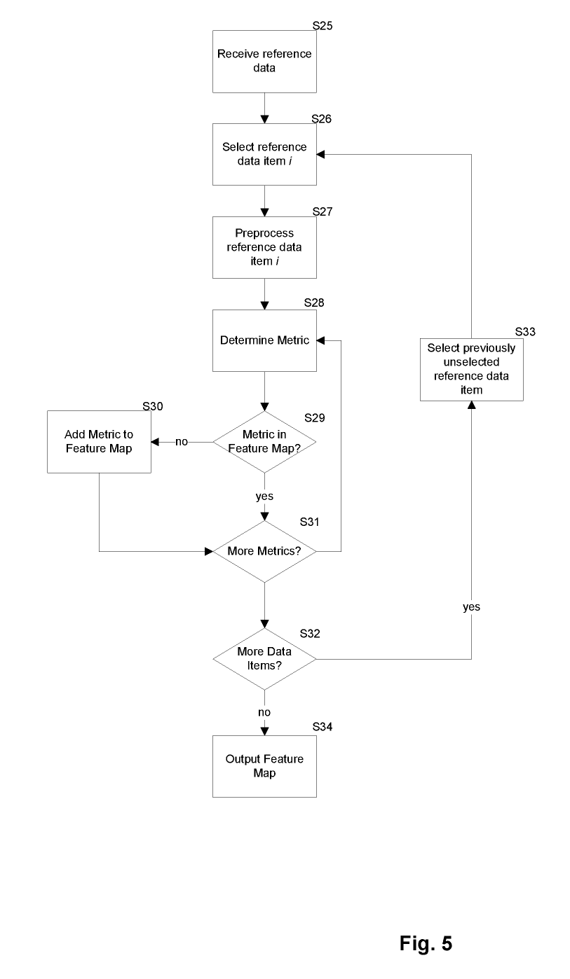

FIG. 5 is a flowchart showing processing of reference data; and

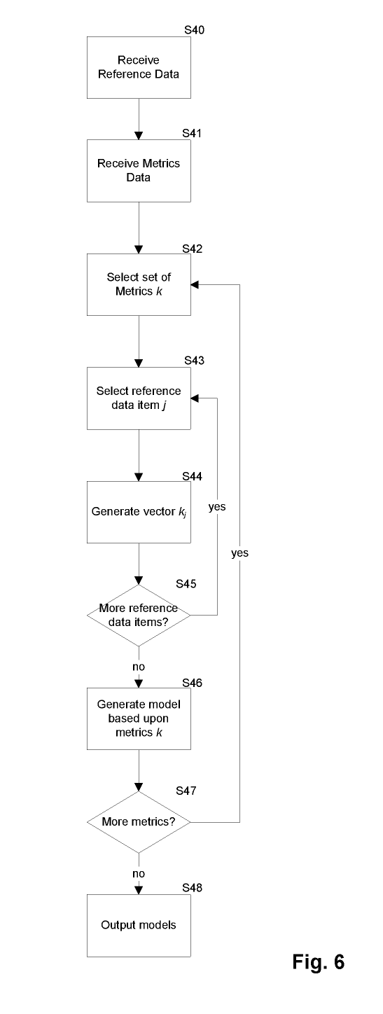

FIG. 6 is a flowchart showing processing to generate a plurality of models from reference data.

Referring to FIG. 1, a plurality of computers 1a, 1b, 1c are arranged to communicate with a plurality of servers 2a, 2b, 2c by way of the Internet 3. The servers 2a, 2b, 2c receive requests from the computers 1a, 1b, 1c and send data to the computers to provide functionality to users of the computers 1a, 1b, 1c such as email functionality, social media functionality and online gaming. The functionality provided by the at least some of servers 2a, 2b, 2c allows users of the computers 1a, 1b, 1c to communicate with other users of the computers 1a, 1b, 1c, for example by sending and receiving emails and other messaging formats.

The ability to send and receive messages by way of the Internet 3 therefore allows a first user of a computer 1a, 1b, 1c to easily communicate with a second user of a computer 1a, 1b, 1c who may or may not be personally known to the first user. In the case where a second user is not known to a first user it is possible for either or both users to create a persona for themselves. For example, in many social media environments users may create a profile that indicates properties of the persona such as an age or a gender. Alternatively in some environments a user may provide such details either directly by stating such details in messages or may suggest such details, for example by way of the content of messages sent by the user.

The Internet 3 provides a way in which users can communicate in an anonymous way and a persona created by a user to communicate with other users may be an identity that does not correspond to the user. For example a user may create a persona with an age, either stated or suggested, that is different to the age of the user. It is therefore desirable to assess properties of a user associated with a persona based upon the content of messages originating from the persona. As shown in FIG. 1, according to the invention a text analysis server 4 is arranged to communicate with computers 1a, 1b, 1c and servers 2a, 2b, 2c by way of the Internet 3 to analyse text that is generated by a persona of a user and determine properties of the user based upon the analysis of the text.

It will of course be appreciated that whilst in the above the text analysis server 4 is described as communicating with computers using the Internet 3, other arrangements by which text is provided to the text analysis server 4 are also possible. For example, text data for analysis may be provided to the text analysis server 4 by any convenient means such as by way of a third party computer or by storing text data retrieved from one of computers 1a, 1b, 1c on a storage device such as a compact disc or any other removable storage and loading the text data on the text analysis server 4 from the storage device. For example, in some embodiments text data may be retrieved from a computer that has been seized as part of a criminal investigation and provided to the text analysis server 4.

FIG. 1A shows the text analysis server 4 in further detail, although it will be appreciated that each of computers 1a, 1b, 1c and servers 2a, 2b, 2c will typically have the same general structure. It can be seen that the computer comprises a CPU 4a which is configured to read and execute instructions stored in a volatile memory 4b which takes the form of a random access memory. The volatile memory 4b stores instructions for execution by the CPU 4a and data used by those instructions. For example, in use, data such as the text to be processed may be stored.

The server 4 further comprises non-volatile storage in the form of a hard disc drive 4c. Data such as identification data and restricted data may be stored on the hard disc drive 4c. The server 4 further comprises an I/O interface 4d to which are connected peripheral devices used in connection with the server 4. More particularly, a display 4e is configured so as to display output from the server 4. The display 4e may, for example, display data representing a likelihood that an age of an author of text falls within one or more age ranges. Input devices are also connected to the I/O interface 4d. Such input devices include a keyboard 4f and a mouse 4g which allow user interaction with the server 4. A network interface 4h allows the server 4 to be connected to an appropriate computer network so as to receive and transmit data from and to other computers such as computers 1a, 1b, 1c and servers 2a, 2b, 2c. The CPU 4a, volatile memory 4b, hard disc drive 4c, I/O interface 4d, and network interface 4h, are connected together by a bus 4i.

Referring to FIG. 2, processing of text to classify the text based upon a property is shown. At step S1 the text is received. The text has an associated source type and comprises a plurality of tokens. Source types may include categories such as email, social media and online gaming and may additionally include sub-categories such as Twitter® and Facebook® sub-categories of social media amongst others.

At step S2 a property based upon which it is desirable to classify the text is received. For example, the property may be an age range or a gender of a persona that authored the text and it may be desirable to classify the author of the text received at step S1 as having an age within the age range or to classify the persona as male or female.

At step S3 the text received at step S1 is processed to determine a plurality of metrics. The plurality of metrics include count data for the plurality of tokens indicating a quantity of each of a plurality of different tokens in the text, part of speech data for the plurality of tokens indicating a count for each of a plurality of different lexical items such as nouns, verbs and adjectives, semantic field data for the plurality of tokens indicating a count for each of a plurality of different semantic categories and at least one metric indicative of a property of the text. The generation of a plurality of metrics may include determination of the plurality of tokens of the text as is described in further detail below with reference to FIG. 3.

At step S4 reference data is selected from a plurality of reference data. The plurality of reference data comprises reference data generated based upon text having a known source type and the reference data is selected based upon the source type associated with the text received at step S1 and the source type associated with the reference data. For example, the reference data may be selected such that the selected reference data has a corresponding source type to the text received at step S1. It has been found that processing text based upon the source type provides improved classification as language style differs based upon the source of the text.

The reference data may be further selected based upon the property received at step S2. For example, each of the plurality of reference data may be generated from text authored by a plurality of individuals having ages within a particular age range and the reference data may be selected based upon an age range indicated by the property received at step S2.

At step S5 the plurality of metrics generated at step S3 are each processed based upon the reference data selected at step S4 to generate data indicating a relationship between each of the plurality of metrics and the reference data. In general terms, the selected reference data comprises a corresponding plurality of metrics and processing the generated plurality of metrics comprises comparing the reference data metrics with the plurality of metrics generated from the text. For example, the data indicating a relationship may comprise a log-likelihood score for each metric, each score indicating a likelihood that the text received at step S1 has the property received at step S2 given the metric value generated from the text. It will of course be appreciated that the data indicating a relationship may be generated in any convenient way and may take the form of scores indicative of a relationship between values other than a log-likelihood score.

At step S6 the data indicating a relationship between each of the plurality of metrics and the reference data is combined to generate a combined likelihood that the text received at step S1 has the property received at step S2. The data may be combined in any convenient way, however it has been found that a weighted combination of the data indicating a relationship between each of the plurality of metrics and the reference data provides improved data analysis. In particular, the weights may be generated based upon the reference data used to determine the data indicating a relationship between each of the plurality of metrics and the reference data. For example the reference data may be processed to generate the weights using regression modelling. In this way, the contribution of each metric to the combined likelihood varies dependent upon the significance of the metric for the property to be determined.

Referring to FIG. 3, the processing to generate a plurality of metrics of the text of step S3 of FIG. 2 is shown in further detail. At step S10 the text is processed to tokenise the text. Tokenising the text may be carried out in any convenient way but in general the text is processed based upon one or more criterion to divide the text into sets of characters and words of predetermined length. In particular the text is processed to determine word, part of speech and semantic tokens in which some multi-word expressions are considered as a single entity, for example in which an expression such as “thank you” is considered as a single entity in the text and the text is further processed to generate a plurality of n-grams based upon characters and words in the text in which “thank you” would be considered as two words.

The n-grams typically include character unigram tokens, character bigram tokens and character trigram tokens comprising respectively one, two and three characters, word unigram tokens, word bigram tokens and word trigram tokens comprising respectively one, two or three words, part of speech unigram tokens, part of speech bigram tokens, part of speech trigram tokens comprising indications of part of speech words and part of speech word combinations of length two and three, and semantic unigram tokens, semantic bigram tokens and semantic trigram tokens comprising indications of semantic words and semantic word combinations. It will of course be appreciated that tokens of any length and/or form can be used to tokenise the text, although it has been found that unigrams, bigrams and trigrams for each of character, word, part of speech and semantic tokenisation provides effective text analysis. In some embodiments the tokens that are selected may be determined based upon metrics identified from reference data, for example indicated in a feature map that is generated for the reference data as described in further detail below with reference to FIG. 5.

At step S11 each category of generated tokens are processed according to a plurality of criterion to generate a plurality of counts for each category. For example, the word unigrams are processed to generate a plurality of counts indicating the number of occurrences of each different word in the text. Similarly the word bigrams and trigrams are processed to generate a count of each occurrence of each word pair and word triple in the text and the character unigrams, bigrams and trigrams are processed in a similar manner to generate a plurality of further counts.

For example, the processing of steps S10 and S11 on the text “My name is James” would generate, amongst others, a uni-gram frequency list for word count:
My: 1
name: 1
is: 1
James: 1
   a bi-gram frequency list for word count:
My name: 1
name is: 1
is James: 1

A uni-gram frequency list for part of speech:
Prenominal: 1
Singular common noun: 1
is: 1
Singular proper noun: 1

A bi-gram frequency list for part of speech:
Prenominal, Singular common noun: 1
Singular common noun, is: 1
is, Singular proper noun: 1
Singular proper noun: 1

A uni-gram frequency list for semantic meaning:
Pronoun: 1
Speech act: 1
Being: 1
Male name: 1

At step S12 the text is processed to generate a plurality of metrics indicative of the content of the text as a whole, or indicative of discrete messages within the text. For example, the text may comprise a plurality of emails and the metrics may indicate an average length in characters and/or an average length in words of the emails. Various metrics that may be used, amongst others, are set out below:

i. Mean message length in characters—the mean length in characters of the messages within the conversation that is being analysed
ii. Mean message length in tokens—the mean length in tokens of the messages within the conversation that is being analysed
iii. Mean Segmental Type to Token Ratio—the text is segmented into chunks (e.g. 100 words), for each chunk the Type to Token Ration (TTR) is calculated and the mean of TTR is calculated (average of all chunk TTR's). TTR is the number of words but with each word only being counted once/number of tokens (total word frequency summed). Ratio shows the ratio between the breadth of the words used vs the number of words used.
iv. Mean Segmental Emotion-Token to Token Ratio—segmented as in iii, but the ratio is the total number of emoticons/total number of words. Shows proportion of the text that are emoticons
v. Mean Segmental Emoticon-Type to Type Ratio—segmented as in iii, but the ratio is the number of emoticons used (each counted once)/total number words (each counted once). Shows proportion of the text that are emoticons in terms of breadth of language used
vi. Mean Segmental Emoticon-Token to Emoticon-Type Ratio—segmented as in iii, but the ratio is the total number of emoticons/total number of emoticons (each counted once). Shows breadth of emoticons used in ratio to frequency of use.
vii. Mean Segmental Non-Dictionary-Token to Token Ratio—segmented as in iii, but the ratio is the total number of non-dictionary words (those not known)/total number of words. Shows proportion of the text that are non-dictionary words.
viii. Mean Segmental Non-Dictionary-Type to Type Ratio—segmented as in iii, but the ratio is the number of non-dictionary words used (each counted once)/total number words (each counted once). Shows proportion of the text that are non-dictionary words in terms of breadth of language used
ix. Mean Segmental Non-Dictionary-Token to Non-Dictionary-Type Ratio—segmented as in iii, but the ratio is the total number of non-dictionary words/total number of non-dictionary words (each counted once). Shows breadth of non-dictionary words used in ratio to frequency of use.
x. Mean Segmental Mean Token Length—segmented as in iii, using the average length of all the words in the text
xi. Mean Segmental Mean Type Length—segmented as in iii, using the average length of all the words in the text (but each only counted once)
xii. Mean Segmental Punctuation to Character Ratio—segmented as in iii, but using the ratio of frequency of punctuation/frequency of characters
xiii. Mean Segmental Repeated-Punctuation to Character Ratio—segmented as in iii, but using the ratio of frequency of repeated punctuation (e.g. ‘ . . . ’)/frequency of characters
xiv. Mean Segmental Specific-Punctuation to Character Ratio (for each of ‘|’, ‘?’, ‘.’, ‘,’)—segmented as in iii, but using the ratio of frequency of specify punctuation/frequency of characters
xv. Mean Segmental Specific-Punctuation to Punctuation Ratio (for each of ‘|’, ‘?’, ‘.’, ‘,’)—segmented as in iii, but using the ratio of frequency of specify punctuation/frequency of all punctuation

The processing of FIG. 2 is based upon received text from a single source. However where the property upon which the text is to be classified is a property associated with a persona that authored the text it has been found that processing text associated with the persona from a plurality of different source types provides improved classification. In particular, as noted above it has been found that processing text based upon the source type of the text can provide improved classification as different styles are often used by a single persona dependent upon the medium in which the text is presented. As such, processing to classify text from a plurality of sources is shown in FIG. 4.

At step S15 of FIG. 4 text from a plurality of source types associated with a persona is received and at step S16 a property based upon which it is desirable to classify the text is received. At step S17 text having a source type of the plurality of source types is selected and at step S18 relationship data is generated from the source type as described above with reference to FIG. 2. In particular, a combined relationship is generated based upon a relationship between a plurality of metrics generated from the text having the selected source type and reference data selected based upon the selected source type.

At step S19 a check is carried out to determine whether there are more sources to be processed. If it is determined that there are more source types to be processed then processing passes to step S17 where text is selected having a source type that has not previously been selected. Otherwise, if all of the text has been processed based upon respective source types of the text processing passes from step S19 to step S20 where the relationship data for each of the source types is combined to generate a multiple source type categorisation for the text.

The relationship data for each of the source types may be combined in any convenient way. For example, the relationship data for each of the source types may be combined using a weighted combination that weights each of the source types based upon a relative quantity of text in the source type. In particular, a source type that comprises a relatively large proportion of the total quantity of text may be weighted such that the contribution of the relationship data for that source type to the multiple source type categorisation for the text is relatively high. Alternatively the weighted combination may be based upon data indicative of the relevance of a source type to categorisation of a particular property. For example, a plurality of different source types may be processed using a regression model to determine the predictive strength of text from a source type and weights may be generated based upon the predictive strength of text from source types that are used in the combination.

The methods described above to process text to generate data indicative of a property associated with text may be used to process the text based upon a plurality of properties to generate a binary decision tree indicating likelihoods at each of the branches of the decision tree that the text has a particular property. For example, where it is desirable to categorise a persona that authored the text as having a particular age, the text may be processed based upon a plurality of different age categories and a likelihood that the persona that authored the text belongs to each of two categories may be determined at each branch of the decision tree with each branch determining a sub-category of the node above.

For example, in order to categorise a persona that authored the text as belonging to an age category the text may first be processed based upon reference data that comprises text authored by individuals having an age greater than 18 and text authored by individuals having an age less than 18 and a likelihood that the persona that authored the text has an age in each of the categories may be determined. The text may then be processed according to the methods described above based upon reference data associated with sub-categories of each of the initial categories to generate further likelihoods. For example, the text may be processed based upon reference data that comprises text authored by individuals having an age between 11 and 14, an age between 15 and 18, an age between 19 and 25 and an age greater than 25.

It is indicated above with reference to step S6 of FIG. 2 that determined relationships may be combined in any convenient way. For example, where two categories are processed to generate a binary tree, at least some of the metrics may be processed to provide a binary value for the metric indicating which of the two categories provides the shortest log-likelihood distance score for that metric. For example, where categories greater than or equal to 18 and less than 18 are compared at a node, values as shown below in Table 1 may be provided in which the value “Other Metrics” indicates an averaged binary value for a plurality of metrics indicating that 30% of metrics other than word, part of speech and semantic metrics indicate a shortest log-likelihood distance for category less than 18 and 70% of the metrics indicate a shortest log-likelihood distance for category greater than 18.

TABLE 1

| | <18 | >=18 |
|---|---|---|
| Other Metrics | 0.3 | 0.7 |
| Word | 1 | 0 |
| POS | 0 | 1 |
| Semantic | 0 | 1 |

A percentage value for each category may be calculated by dividing the total score by the total possible score. For example, for Table 1 above category <18 would have a percentage score 1.3/4=0.325=32.5% and category >=18 would have a percentage score 2.7/4=0.675=67.5. As described above with reference to step S6 of FIG. 2, each metric is typically weighted, between 0 and 1.

For example, for the values above shown in Table 1, weights as shown in Table 2 may be used.

TABLE 2

| | Weight |
|---|---|
| Other Metrics | 0.7 |
| Word | 0.6 |
| POS | 0.8 |
| Semantic | 0.7 |

Applying the weights of Table 2 to Table 1 provides values as shown in Table 3.

| | <18 | >=18 |
|---|---|---|
| Other Metrics | 0.21 | 0.49 |
| Word | 0.6 | 0 |
| POS | 0 | 0.8 |
| Semantic | 0 | 0.7 |

And the percentage values are modified accordingly such that category <18 has weighted percentage 0.81/2.8=0.2893=28.93% and category >18 has weighted percentage 1.99/2.8=0.7107=71.07%.

It will be appreciated that at each sub-category the confidence associated with classification of the persona that authored the text to the categories will reduce such that the tree structure provides a plurality of paths through the tree, each path having an associated confidence. The binary decision tree can be processed using a strongest path algorithm to select the category for the text that most likely indicates the property, such as the age category, of the persona that authored the text.

The methods described above use reference data to process received text to generate the data indicative of a property associated with the text where the reference data based upon which the received text is processed has a known property. The reference data may be obtained from any convenient source, although it will be appreciated that in some embodiments described above the source of the reference data is used in the selection of the reference data. Example sources of reference data that have been used include the British National Corpus, version 3 (BNC XML Edition), 2007, which is distributed by Oxford University Computing Services on behalf of the BNC Consortium and can be obtained from URL: http://www.natcorp.ox.ac.uk/) and extraction of text from social media websites such as Twitter and Facebook. For example, text data having known associated age categories may be obtained from social media sites by extracting text data from users whose ages are known such as verified social media profiles.

Reference data for particular properties and source types can be generated by recruiting appropriate people to experimental sessions. Preferably and subject to ethical considerations, the participants may be asked to complete suitable communications tasks so as to obscure the primary purpose of the session, and hence minimise bias.

The text data may be processed in accordance with the processing of FIG. 3 to generate metrics that may be used as the reference data for analysis of text. It will of course be appreciated that the same text data may be used for multiple categories. For example, where a property to be analysed is based upon age, text that is known to be associated with an individual having a particular age may be used in the generation of reference data for all categories and sub-categories that the particular age falls within.

Alternatively in some embodiments the tokens that are used in the determination of a property associated with a text may be determined based upon metrics identified by processing the reference data, as will now be described with reference to FIG. 5. The processing of FIG. 5 identifies metrics of the reference data that are suitable for classification of text.

Referring to FIG. 5, at step S25 reference data is received. The reference data comprises a plurality of data items i, each data item i comprising text and having an associated property. Each data item i may additionally have an associated known source type. At step S26 a data item i of the reference data is selected and at step S27 the data item i is processed to tokenise the text in the manner described above with reference to step S10 of FIG. 3.

The processing of steps S28 to S33 iteratively processes the currently selected data item i to determine all metrics of the data item that satisfy a predetermined criterion and populates a feature map with the determined metrics. The processing of steps S28 to S33 is repeated for each data item i of the reference data such that a feature map is populated with all metrics of the reference data that meet the predetermined criterion.

In more detail, at step S28 a metric of the data item is determined based upon a predetermined criterion. The predetermined criterion may for example be based upon a relative frequency or total number of occurrences of a particular lexico-syntactic pattern such as an expression or combination of tokens having a particular form in the text. For example, each of the metrics described above with reference to step S12 of FIG. 2 may each form the basis of a predetermined criterion based upon an associated frequency or total number of occurrences.

At step S29 a check is performed to determine whether the metric determined at step S28 is in the feature map and if the metric is not in the feature map then at step S30 the feature map is updated to include the metric determined at step S28. At step S31 it is determined whether more metrics of the data item satisfy the predetermined criteria and if more metrics remain to be processed processing passes to step S28 where the further metric is determined and processed to add the metric to the feature map.

If it is determined at step S31 that no more metrics remain in the currently processed data item then at step S32 a check is carried out to determine whether further reference data items remain to be processed. If further data items are to be processed then at step S33 the counter i is incremented and the processing of steps S26 to S32 are repeated for the further data item to extract all metrics that satisfy the predetermined criterion from the remaining data items. Otherwise at step S34 the feature map is output.

Metrics indicated in the feature map may be used in the methods described above with reference to FIGS. 2, 3 and 4. That is, the plurality of metrics that are generated from a text may be the plurality of metrics indicated in the feature map and the reference data is processed based upon the same metrics.

It is described above that a plurality of metrics are processed based upon reference data to generate data indicating a relationship between each of the plurality of metrics and the reference data, for example by comparing the reference data metrics with the plurality of metrics generated from the text. An alternative method for generating data indicating a relationship between input text and reference data will now be described with reference to FIG. 6.

Referring to FIG. 6, processing to generate a plurality of models is shown. At step S40 reference data is received and at step S41 metrics data is received. Metrics data received at step S41 comprises a plurality of sets of metrics and may for example be indicated by a feature map that is generated based upon a predetermined criterion according to the processing of FIG. 5. For example, the processing of FIG. 5 may be carried out on the reference data based upon a plurality of predetermined criteria to generate a corresponding plurality of feature maps and the metrics data may comprise the plurality of feature maps. The plurality of feature maps may for example be generated based upon a plurality of predetermined criteria that results in three feature maps, each feature map indicating metrics of one of a corresponding three types. For example the plurality of feature maps may comprise a feature map indicating stylometric metrics, a feature map indicating lexical choice metrics and a feature map indicating content feature metrics. Alternatively the plurality of sets of metrics of the metrics data may be generated in any convenient way, for example based upon user selection of metrics.

At step S42 a set of metrics k is selected and at step S43 a reference data item j of the reference data is selected. At step S44 a vector kⱼ is generated by processing the reference data item j based upon the metrics k. In particular, the reference data item j is processed based upon each of the metrics to generate a value for each metric and a corresponding element of the vector kⱼ is populated with the value generated for the metric. For example, where the metrics are provided by a feature map, the feature map may indicate the element of the vector that corresponds to each metric. The vector additionally includes an element indicating a property associated with the reference data item j, corresponding to a property based upon which it is desirable to assess text, as described in detail above.

At step S45 a check is carried out to determine whether more reference data items remain to be processed and if it is determined that there are more data items to be processed then the processing of steps S43 to S45 is repeated with a previously unprocessed data item.

If it is determined at step S45 that all reference data items have been processed based upon the set of metrics k selected at step S42 then at step S46 the plurality of vectors are processed to generate a reference model for the set of metrics k. The reference model may be any suitable model for generating output indicating how well the model fits to unseen data of a corresponding form, any may for example be a support vector regression model generated using a Support Vector Machine as is known in the art. Support Vector Machines are described for example in N. Cristianini, J. Shawe-Taylor, “An introduction to Support Vector Machines and other kernel-based learning methods”, Cambridge University Press, New York, N.Y., USA (2000), which is hereby incorporated by reference.

At step S47 a check is carried out to determine whether more sets of metrics remain to be processed and if it is determined that more sets of metrics remain to be processed then processing passes to step S42 where a previously unprocessed set of metrics is selected and the processing of steps S43 to S46 is repeated based upon the selected set of metrics to generate a further model for the selected set of metrics. Otherwise at step S48 the plurality of generated models is output. It will of course be appreciated that each model may be output once it has been generated after step S46.

It will be appreciated that the processing of FIG. 6 may be repeated to generate a set of models for each of a plurality of reference data, each of the plurality of reference data being associated with a source type as described above.

The models output from the processing of FIG. 6 may be used at step S5 of FIG. 2 to determine a relationship between the sets of metrics associated with the model and received text. For example, the text received at step S1 of FIG. 2 may be processed at step S3 based upon a feature map to generate a vector corresponding to the vector generated at step S44 of FIG. 6 using the same feature map and the models may each be fitted to the vector to determine a plurality of relationships between the reference data and the text. The relationships may for example take the form of a numerical indication of the quality of the fit of the model to the vector and the relationships may be combined at step S6 to generate a combined likelihood that the text received at step S1 has the property received at step S2. In some embodiments, for example where the plurality of models are each a support vector regression model, the data indicating a relationship may take the form of a likelihood that the text is associated with a property and likelihoods associated with properties generated by respective models may be combined to provide a combined likelihood that the text is associated with one of the properties.

Whilst the processing of FIGS. 5 and 6 have been described above as separate processing, parts of the processing of FIGS. 5 and 6 may be carried out in parallel. In particular, the generation of a vector kⱼ for a data item j of step S44 may be carried out simultaneously with the processing of the same data item at steps S27 to S31 of FIG. 5. In particular, where a metric is identified at step S28 of FIG. 5 the value associated with the metric for the data item j may be stored and the stored value may subsequently be used in the generation of the vector kⱼ. In this way processing is reduced as it is only necessary to process the data item j with respect to the metric a single time.

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

1.-27. (canceled)

28. A method of processing text having an associated source type to generate data indicative of a property associated with said text, said text comprising a plurality of tokens, the method comprising:
generating a plurality of metrics of said text based upon said plurality of tokens, the plurality of metrics comprising token count data for said plurality of tokens, part of speech data for said plurality of tokens, semantic field data for said plurality of tokens and at least one metric indicative of a property of the text;
selecting reference data from a plurality of reference data based upon the source type associated with the text;
processing each of said plurality of metrics of said text based upon the reference data to generate data indicating a relationship between respective ones of said plurality of metrics and said reference data; and
combining the data indicating a relationship between the respective ones of the plurality of metrics and said reference data to generate the data indicative of a property associated with said text;
wherein first data indicative of a first property of the author of said text is generated based upon a first selected reference data;
wherein second data indicative of a second property of the author of said text is selected based upon a second reference data; and
wherein one of said first and second properties is selected based upon said first and second data.

29. A method according to claim 28, further comprising:
generating further data indicative of a further property of the author of the text based upon further reference data, the further reference data being selected based upon the selected one of the first and second properties.

30. A method according to claim 29, wherein the further property is a sub-category of the selected one of the first and second properties.

31. A method according to claim 28, wherein said combining comprises processing the data indicating a relationship between the respective ones of the plurality of metrics and said reference data to provide a binary value for at least one metric of the plurality of metrics indicating which of the first and second properties provides a shortest distance score for the at least one metric to generate said first and second data.

32. A method according to claim 29, further comprising:
selecting, using a strongest path algorithm, one of the first, second or further properties based upon the first, second and further data.

33. A method according to claim 28, wherein the source type indicates one of a plurality of computer mediated and online communications media.

34. A method according to claim 33, wherein the plurality of digital communications media are selected from the group consisting of: email, social networking, micro-blogging and short message service.

35. A method according to claim 28, wherein the combining comprises a weighted combination of the data indicating a relationship between the respective ones of the plurality of metrics and said reference data.

36. A method according to claim 35, wherein weights for the weighted combination are selected based upon said associated source type.

37. A method according to claim 28, further comprising at least one selected from the group consisting of:
the property is age or gender;
the reference data is further selected based upon the property associated with the text;
the reference data comprises corresponding word count data, part of speech data, semantic field data and at least one metric.

38. A method according to claim 28, wherein processing each of said plurality of metrics of said text based upon the reference data to generate data indicating a relationship between respective ones of said plurality of metrics and said reference data comprises determining a correspondence between the reference data and the data generated from said text; and
wherein the correspondence optionally is based upon a count associated with at least some of the metrics; and
wherein determining the correspondence optionally comprises determining a distance score; and
wherein optionally the distance score is based upon a log-likelihood distance score.

39. A method according to claim 28, wherein the text comprises a plurality of texts, each text having an associated source, wherein each of the plurality of texts is processed based upon respective reference data to generate respective data indicating a relationship between respective ones of said plurality of metrics and the reference data for the respective text; and wherein combining the data indicating a relationship between the respective ones of the plurality of metrics and the reference data to generate the data indicative of a property of the author of said text optionally comprises combining the respective data indicating a relationship between respective ones of said plurality of metrics and the reference data for the respective text to generate data indicative of a property of the author of each of the plurality of texts; and combining the data indicative of a property of the author of each of the plurality of texts to generate the data indicative of a property of the author of the text.

40. A method according to claim 28, further comprising:
wherein combining the data indicative of a property of the author of each of the plurality of texts to generate the data indicative of a property of the author of the text comprises a weighted combination; and
wherein each of the plurality of texts is optionally weighted based upon at least one selected from the group consisting of: an amount of the respective text relative to a total amount of the plurality of texts; and a predictive power of text from a source type.

41. A method according to claim 28, wherein said author is an individual or a persona associated with an individual.

42. A method according to claim 28, wherein said plurality of metrics of said text are generated based upon said reference data.

43. A method according to claim 42, wherein generating said plurality of metrics of said text comprises processing said reference data based upon predetermined criteria.

44. A method according to claim 28, wherein said reference data comprises a plurality of models, each model having an associated subset of said plurality of metrics, wherein processing each of said plurality of metrics of said text based upon the reference data comprises processing corresponding subsets of said plurality of metrics based upon the associated models to generate respective data indicating a relationship between each of said subsets of said plurality of metrics and said reference data.

45. A method according to claim 44, wherein each of said plurality of models is a support vector model.

46. A non-transitory computer readable medium carrying a computer program comprising computer readable instructions configured to cause a computer to carry out a method of processing text having an associated source type to generate data indicative of a property associated with said text, said text comprising a plurality of tokens, the method comprising:
generating a plurality of metrics of said text based upon said plurality of tokens, the plurality of metrics comprising token count data for said plurality of tokens, part of speech data for said plurality of tokens, semantic field data for said plurality of tokens and at least one metric indicative of a property of the text;
selecting reference data from a plurality of reference data based upon the source type associated with the text;
processing each of said plurality of metrics of said text based upon the reference data to generate data indicating a relationship between respective ones of said plurality of metrics and said reference data; and
combining the data indicating a relationship between the respective ones of the plurality of metrics and said reference data to generate the data indicative of a property associated with said text;
wherein first data indicative of a first property of the author of said text is generated based upon a first selected reference data;
wherein second data indicative of a second property of the author of said text is selected based upon a second reference data; and
wherein one of said first and second properties is selected based upon said first and second data.

47. A computer apparatus for processing text having an associated source type to generate data indicative of a property associated with said text, said text comprising a plurality of tokens, the apparatus comprising:
a memory storing processor readable instructions; and
a processor arranged to read and execute instructions stored in said memory;
wherein said processor readable instructions comprise instructions arranged to control the computer to carry out a method of processing text having an associated source type to generate data indicative of a property associated with said text, said text comprising a plurality of tokens, the method comprising:
generating a plurality of metrics of said text based upon said plurality of tokens, the plurality of metrics comprising token count data for said plurality of tokens, part of speech data for said plurality of tokens, semantic field data for said plurality of tokens and at least one metric indicative of a property of the text;
selecting reference data from a plurality of reference data based upon the source type associated with the text;
processing each of said plurality of metrics of said text based upon the reference data to generate data indicating a relationship between respective ones of said plurality of metrics and said reference data; and
combining the data indicating a relationship between the respective ones of the plurality of metrics and said reference data to generate the data indicative of a property associated with said text;
wherein first data indicative of a first property of the author of said text is generated based upon a first selected reference data;
wherein second data indicative of a second property of the author of said text is selected based upon a second reference data; and
wherein one of said first and second properties is selected based upon said first and second data.
